(19) United States
(12) Patent Application Publication
(10) Pub. No.: US 2002/0195518 A1
(43) Pub. Date: Dec. 26, 2002

(54) Combination fixed and rotating wing aircraft and land vehicle

(76) Inventor: Norman Don Killingsworth, Costa Mesa, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/208,076

(22) Filed: Jul. 29, 2002

Related U.S. Application Data
(63) Continuation-in-part of application No. 10/096,747, filed on Mar. 12, 2002.
(60) Provisional application No. 60/274,982, filed on Mar. 12, 2001.

(51) Int. Cl. B64C 27/22

(52) U.S. Cl. 244/7 A

(57) ABSTRACT

An aeronautical body is enabled for carrying personnel, and mounted in laterally extending positions from the side surfaces of the body are a pair of medially placed main wings and a pair of proximally placed canard wing tips. In spaced apart proximity to the side and top surfaces of the body, and mounted therefrom, a pair of horizontal stabilizer wings and a propulsion device are placed. A pair of helicopter rotor assemblies are mounted at mutually divergent angles such that a pair of rotor blades are enabled for rotation without mutual interference. The body is mounted on wheels enabled for supporting, propelling and steering the apparatus in movements on a hard surface.

### RELATED APPLICATIONS

This application claims the priority date of a prior filed provisional patent application filed with the United States Patent & Trademark Office on Mar. 12, 2001 as serial No. 60/274,982 and which discloses a similar invention as herein claimed. The present application also is related to U.S. application Ser. No. 10/096,747 filed on Mar. 12, 2002 and which teaches a similar apparatus using similar technology. Applicant hereby incorporate herein by reference, any and all U.S. patents, U.S. patent applications, and other documents and printed matter cited or referred to in this application.

### BACKGROUND OF THE INVENTION

1. Field of the Invention

This invention relates generally to aircraft and a land convertible vehicles able to move personnel on land and through the air as a fixed wing aircraft and a rotating wing aircraft.

2. Description of Related Art

The prior art teaches automotive vehicles, especially in military applications for moving personnel. The prior art also teaches fixed wing craft having propulsion for driving such craft through the air in horizontal flight. Also, the prior art teaches rotor driven craft such as helicopters that are able to operate from a fixed landing position with vertical and horizontal maneuvers. These vehicles are well known in the art. However, the prior art does not teach a single vehicle capable of all of the foregoing. The present invention fulfills these needs and provides further related advantages as described in the following summary.

### SUMMARY OF THE INVENTION

The present invention teaches certain benefits in construction and use which give rise to the objectives described below.

An aeronautical body is enabled for carrying personnel, and mounted in laterally extending positions from the side surfaces of the body are a pair of medially placed main wings and a proximally placed canard wing. Vertical and horizontal stabilizer wings and a propulsion device extend from the body. A pair of helicopter rotor assemblies are mounted at mutually divergent angles such that a pair of rotor blades are enabled for rotation without mutual interference. The body is mounted on wheels enabled for supporting, propelling and steering the apparatus in movements on a hard surface.

A primary objective of the present invention is to provide an apparatus and method of use of such apparatus that provides advantages not taught by the prior art.

Another objective is to provide such an invention capable of traveling on land and through the air.

A further objective is to provide such an invention capable of fixed wing and helicopter flight.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective frontal view of the preferred embodiment of the invention showing the several features and adaptations; and

FIG. 2 is a partial perspective rear view thereof.

### DETAILED DESCRIPTION OF THE INVENTION

The above described drawing figures illustrate the invention in at least one of its preferred embodiments, which is further defined in detail in the following description.

The present invention, as shown in FIGS. I and 2, is a vehicular apparatus comprising an airfoil shaped, van-like body 10 enabled by having interior space, seats, luggage facilities, etc., for carrying personnel and material. To make such a van body 10 airworthy, it is made of light materials such as fiber reinforced composites, titanium, etc. The body 10 has opposing side surfaces 12, 14 and a top surface 16. The sides 12, 14 are integral with a flared-out sponson 12′, 14′, one on each side, and these provide interior spaces used for carrying supplies and for providing floatation. Located between the sponsons 12′, 14′ and below a floor 19 of the apparatus is a fuel tank 8. Mounted in laterally extending positions from the side surfaces 12, 14 are a pair of medially placed main wings 20, 22 and a pair of proximally placed canard wing tips 30, 32. The main wings 20, 22 provide aerodynamic lift to the apparatus, while the canard wing tips 30, 32 provide further lift and axial stability. The canard wing tips 30, 32 may also be used as control surfaces as is well known in the art. In one embodiment, an inverted, U-shaped shroud 40 may be used but the preferred embodiment does not require such. A horizontal lift surface 42 and laterally positioned vertical stability surfaces 44 provide yaw control in flight. Control surfaces respective of the wings and stabilizers are not shown, but are necessary for flight control and are features well known in aeronautical design and construction. A pair of horizontal stabilizer wings 50, 52 and at least one jet engine 60 is mounted as shown. The wings 50, 52 and engine 60 may be mounted directly on the surfaces 42 and 44 in an alternate embodiment with or without the shroud 40 present. A pair of helicopter rotor assemblies 70,. 72 are medially mounted at mutually divergent angles such that a pair of rotor blades 74, 76 are enabled for rotation without mutual interference. The van-like body 10 is mounted, on wheels 80 enabled, as is known in the automotive industry, for supporting, propelling and steering the apparatus in movements over any hard surface. In the preferred embodiment the wheels 80 are, in fact, electrical motors with the stators fixed to axles and the rotors engaged with tires for rotation. Such wheel configurations are well known in the art. Steering is conventional.

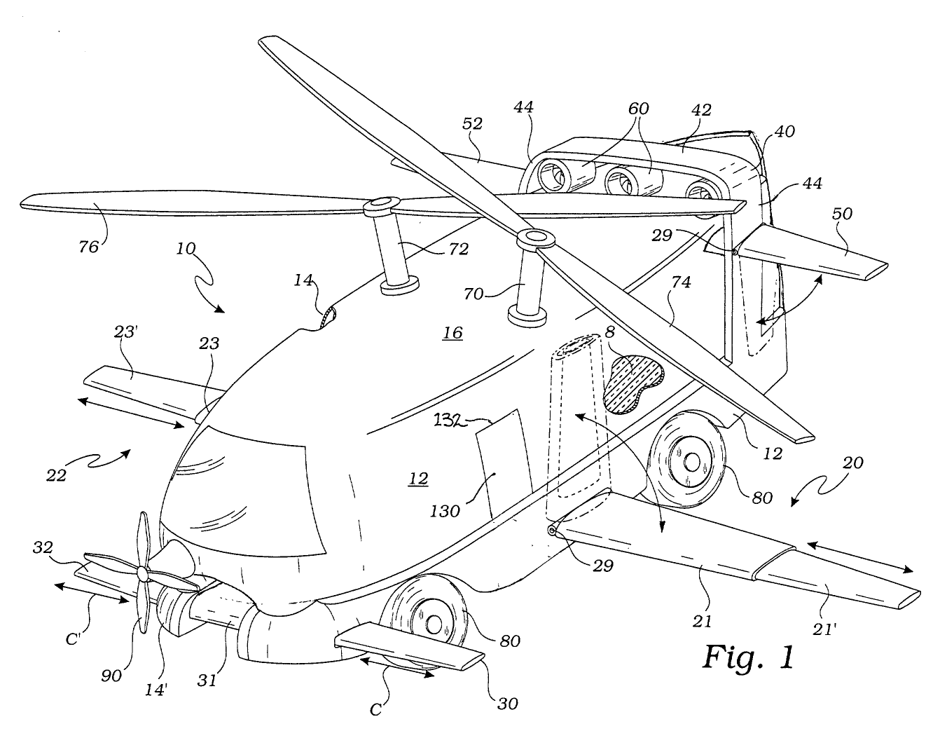

The main 20, 22 and stabilizer 50, 52 wings are enabled by hinging means 29 and positional locking means (not shown) for folding into vertical storage positions. It is shown in FIG. 1, that the preferred folded and storage position for main 20, 22 wings is against the side surfaces 12, 14 of the body 10. Further, that the preferred storage position for the canard wing tips 30, 32 is within canard wing tip storage space 31 into which these wing tips can slide laterally as shown by arrows C and C′. It is yet further shown in FIG. 1, that the preferred folded and storage position for the stabilizer wings 50, 52 is downward.

The main wings 20, 22 preferably each comprise a wing terminal portion 21′, 23′ enabled for linear movement, with respect to a base portion 21, 23 between an extended position for flight, wherein the wings 20, 22 are extended in a dihedral angle outwardly from the body 10, and a retracted position for land operations when the main wings 20, 22 are folded into vertical positions against the body 10.

Such wing construction and adjustability is well known in the art of fighter jet aircraft operating from aircraft carriers.

The helicopter rotor assemblies 70, 72 are adapted for tilting the helicopter rotor blades to a forward angle of approximately seven and one-half degrees and also to a reward angle of approximately seven and one-half degrees. The devices and apparatus for accomplishing this are well known in the art.

The apparatus further preferably comprises a proximal propeller 90, preferable driven for providing forward thrust to the apparatus and this may be embodied in accordance with well known aircraft construction principals used in the aircraft industry.

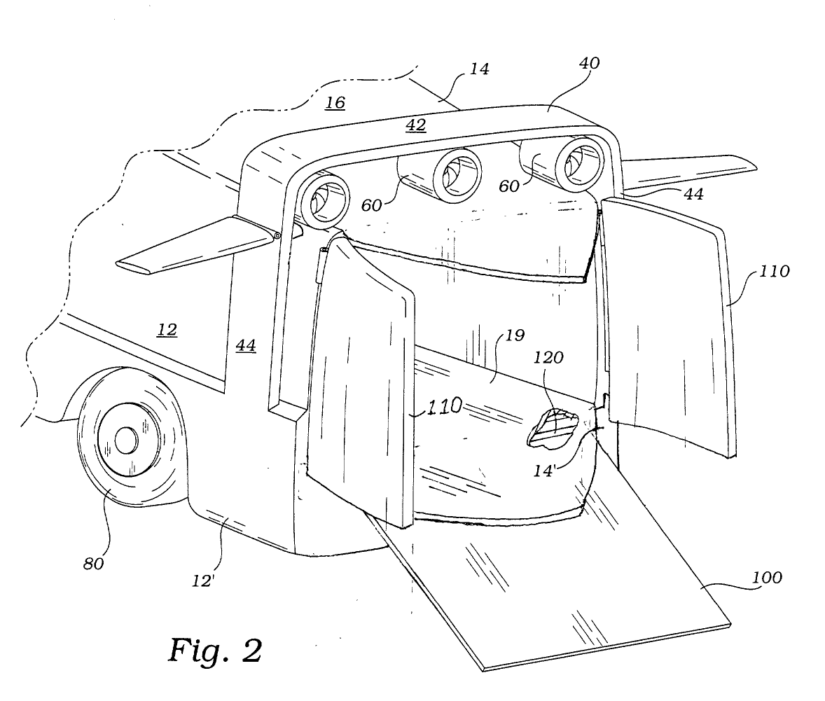

The van-like body 10 provides a distally placed means for entry, preferably an entry ramp 100 and doors 110 (FIG. 2), the ramp 100 enabled by its size and weight for storage below the interior floor 19 of the body 10 in a space 120.

The van-like body 10 provides a medially placed means for entry 130, as shown in FIG. 1, which preferably opens in the manner of an aircraft door having attached stairs 132. The movements of the wings and doors of the present invention may be accomplished manually or through servo-actuators as is well known in the art. Latching of these moving items in stored and deployed positions may also be accomplished through manual or servo-means. The means for accomplishing these actuations, latchings, etc. is well known in the art.

Clearly, the present invention, to meet the objectives defined above, requires controls as are well known in the automotive arts as to type, placement and operation. Also, the means for driving and tilting the rotors, controlling aerodynamic surfaces and all other means for practical flight (not shown) as a fixed wing or rotating wing craft are a necessary part of the present invention, and these elements, also, are well known in the art so that one of skill in the automotive and aircraft arts would find no trouble in making and using the present invention. However, the present configuration of an aeronautical body configured for land operations as well as two modes of flight is not known in the art and such a combination, as described herein comprises the inventive novelty of the present disclosure.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A vehicular apparatus comprising: an aeronautical body enabled for carrying personnel, the body having opposing side surfaces and a top surface; and mounted in laterally extending positions from the side surfaces; a pair of medially placed main wings and a pair of proximally placed canard wing tips; a pair of distally placed horizontal stabilizer wings and at least one thrust producing engine for level flight is engaged with the body; a pair of helicopter rotor assemblies mounted at mutually divergent angles such that a pair of rotor blades are enabled for rotation without mutual interference; the body mounted on wheels enabled for supporting, propelling and steering the apparatus in movements on a hard surface.

2. The apparatus of claim 1 further comprising a U-shaped shroud supported in spaced apart proximity to the side and top surfaces, and mounted therefrom.

3. The apparatus of claim 1 wherein each of the main, canard and stabilizer wings are enabled for moving into a non-laterally extending storage position for land operations.

4. The apparatus of claim 1 wherein the main wings each comprise a wing terminal portion enabled for telescopic movement between an extended position for horizontal flight and a retracted position for land operations.

5. The apparatus of claim 1 wherein the helicopter drive assemblies are adapted for tilting the helicopter rotor blades to a forward angle of approximately seven and one-half degrees and also to a reward angle of approximately seven and one-half degrees.

6. The apparatus of claim 1 wherein the body provides a distally placed means for entry.

7. The apparatus of claim 6 wherein the distal means for entry includes a ramp, the ramp enabled for storage below an interior floor of the body.

8. The apparatus of claim 1 wherein the body provides a medially placed means for entry.

9. The apparatus of claim 1 further comprising spaced apart sponsons positioned below the side surfaces laterally to the body.
